(19) United States
(12) Patent Application Publication
(10) Pub. No.: US 2026/0131628 A1
(43) Pub. Date: May 14, 2026

(54) HEAT EXCHANGER COMBINED CONTROLLER AND HEAT MANAGEMENT SYSTEM USING THE SAME

(71) Applicants: Hyundai Motor Company, Seoul (KR); Kia Corporation, Seoul (KR)

(72) Inventors: Jong Won Kim, Hwaseong-si (KR); Dae Kyu Han, Hwaseong-si (KR); Seong Eun Kim, Hwaseong-si (KR)

(21) Appl. No.: 19/202,475

(22) Filed: May 8, 2025

(30) Foreign Application Priority Data
Nov. 12, 2024 (KR) 10-2024-0159783

(51) Int. Cl. B60H 1/00; F28D 9/00; F28D 21/00

(52) U.S. Cl. CPC B60H 1/00878; F28D 9/0031; F28D 2021/008

(57) ABSTRACT

A vehicle heat exchanger combined controller system can include a controller configured to perform a dummy operation, and a heat exchange plate having a coolant path for the controller, capable of performing heat exchange between heat emitted through the dummy operation of the controller and a coolant passing through the coolant path of the heat exchange plate. After heat exchange at the heat exchange plate, the coolant can be used for heating and/or battery temperature increase.

### CROSS-REFERENCE TO RELATED APPLICATIONS

This application claims under 35 U.S.C. § 119(a) the benefit of priority from Korean Patent Application No. 10-2024-0159783 filed on Nov. 12, 2024, the entire contents of which are incorporated herein by reference.

### TECHNICAL FIELD

The present disclosure relates to a vehicle heat exchanger combined controller system and a heat management system using the same.

### BACKGROUND

An electric vehicle is provided with an air conditioning system including a compressor, a condenser, and an evaporator for cooling and heating the interior of the vehicle, and a heat management system for cooling batteries, motors, and power electronic (PE) components and recovering waste heat.

The air conditioning system includes various heat exchangers, such as an evaporator core and a heater core, to implement a heating mode, a heating-dehumidifying mode, and a cooling mode, and the heat management system also includes various heat exchangers, such as a chiller and a heater (e.g., a PTC (Positive Temperature Coefficient) heater and a battery heater), to implement a battery heating mode, a motor and battery cooling mode, and the like.

To resolve problems of increased number of parts and increased cost due to the inclusion of multiple heat exchangers in existing air conditioning and heat management systems, a method is being sought to remove or modify some heat exchangers (e.g., the PTC heater or the battery heater) to reduce the number of parts and cost.

The above information disclosed in this Background section is only for enhancement of understanding of the background of the present disclosure and therefore it may contain information that does not form the prior art that is already publicly known, available, or in use.

### SUMMARY

The present disclosure relates to a vehicle heat exchanger combined controller system and a heat management system using the same, and more specifically, to a vehicle heat exchanger combined controller system capable of using heat generated by a dummy operation of a controller for heating and/or battery temperature increase, and a heat management system using the same.

An embodiment of the present disclosure can solve the above-described problems associated with prior art, and an embodiment of the present disclosure can provide a vehicle heat exchanger combined controller including a controller that performs a dummy operation, and a heat exchange plate having a coolant path mounted in the controller, capable of performing heat exchange between heat generated by the dummy operation of the controller and a coolant passing through the coolant path of the heat exchange plate, to use the coolant after heat exchange for heating and battery temperature increase, for example, and a heat management system using the same.

An embodiment of the present disclosure can provide a vehicle heat exchanger combined controller including a controller configured to perform a vehicle control operation and a dummy operation, and a heat exchange plate formed with a coolant path therein and attached to one surface of the controller, in which heat exchange can be performed between heat generated by the dummy operation of the controller and a coolant passing through the coolant path of the heat exchange plate.

In an embodiment of the present disclosure, a controller may be configured to include a printed circuit board, and a plurality of processors and memories mounted on the printed circuit board to perform the vehicle control operation and the dummy operation for heat generation.

In an embodiment of the present disclosure, a controller may further include a data input unit that replicates and amplifies a vehicle control input signal to generate a dummy signal, and inputs the generated dummy signal to each processor.

In an embodiment of the present disclosure, a processor may be configured to repeatedly perform a meaningless operation for heat generation on the basis of the dummy signal input through the data input unit and not output a repeated operation signal.

In an embodiment of the present disclosure, a heat sink that transfers heat generated by the dummy operation to the coolant path of the heat exchange plate may be further attached to one side of the controller.

In an embodiment of the present disclosure, at least two partitions having a length smaller than a width of the heat exchange plate may be formed in the heat exchange plate in a zigzag form while maintaining a set, predetermined, or selected distance, so that the coolant path is formed in an “S” shape from a coolant inlet to a coolant outlet.

In an embodiment of the present disclosure, a single partition having a length smaller than a length of the heat exchange plate may be formed in the heat exchange plate, so that the coolant path is formed in a “U” shape from a coolant inlet to a coolant outlet.

An embodiment of the present disclosure can provide a heat management system including a controller configured to perform a vehicle control operation and/or a dummy operation, a heat exchange plate formed with a coolant path therein and attached to one surface of the controller, a water-cooled heat exchanger configured to recover heat for heating or battery temperature increase, a first coolant circulation line connected between an outlet of the coolant path of the heat exchange plate and an inlet of the water-cooled heat exchanger, and a second coolant circulation line connected between an outlet of the water-cooled heat exchanger and an inlet of the coolant path of the heat exchange plate.

In an embodiment of the present disclosure, a system may further include an air conditioning controller that transmits a signal for notifying the controller that the amount of heat for heating or battery temperature increase is insufficient compared to a reference amount of heat.

In an embodiment of the present disclosure, a system may further include a temperature sensor that detects a temperature of a coolant passing through the coolant path of the heat exchange plate and transmits a detection signal to the controller.

In an embodiment of the present disclosure, a system may further include an electric water pump that is mounted on the second coolant circulation line and circulates a coolant.

In an embodiment of the present disclosure, a controller may be configured to include a printed circuit board, and a plurality of processors and memories mounted on the printed circuit board to perform the vehicle control operation and/or the dummy operation for heat generation.

In an embodiment of the present disclosure, a controller may further include a data input unit that duplicates and amplifies a vehicle control input signal to generate a dummy signal, and inputs the generated dummy signal to each processor.

In an embodiment of the present disclosure, a processor may be configured to repeatedly perform a meaningless operation for heat generation on the basis of the dummy signal input through the data input unit and not output a repeated operation signal.

In an embodiment of the present disclosure, a heat sink that transfers heat generated by the dummy operation to the coolant path of the heat exchange plate may be further attached to one side of the controller.

In an embodiment of the present disclosure, in an example where a coolant passing through the coolant path of the heat exchange plate is heated by the heat generated by the dummy operation of the controller and passes through the water-cooled heat exchanger along the first coolant circulation line, heat for heating or battery temperature increase may be recovered from the heated coolant.

It can be understood that the term “vehicle” or other similar terms as used herein can be inclusive of motor vehicles in general such as passenger automobiles including sport utility vehicles (SUV), buses, trucks, tractors, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum), for example. As referred to herein, a hybrid vehicle can be a vehicle that has two or more sources of power, for example, vehicles powered by both gasoline and electricity.

### BRIEF DESCRIPTION OF THE DRAWINGS

The above and other features of the present disclosure will now be described in detail with reference to certain example embodiments illustrated in the accompanying drawings, which are given hereinbelow for illustration, and thus are not necessarily limitative of the present disclosure, and wherein:

FIG. 1 is a perspective view showing a vehicle heat exchanger combined controller according to an embodiment of the present disclosure;

FIG. 2 is a perspective view showing a part of a heat exchange plate of a vehicle heat exchanger combined controller according to an embodiment of the present disclosure;

FIG. 3 is a perspective view showing a vehicle heat exchanger combined controller according to an embodiment of the present disclosure;

FIG. 4 is a perspective view showing a part of a heat exchange plate of a vehicle heat exchanger combined controller according to an embodiment of the present disclosure;

FIG. 5 is a side-sectional view showing a vehicle heat exchanger combined controller according to an embodiment of the present disclosure;

FIG. 6 is a coolant circulation flow diagram showing a heat management system including a vehicle heat exchanger combined controller and a water-cooled heat exchanger according to an embodiment of the present disclosure;

FIG. 7 is a side-sectional view showing a connection relationship between a vehicle heat exchanger combined controller and a water-cooled heat exchanger according to an embodiment of the present disclosure;

FIG. 8 is a configuration diagram illustrating a vehicle control operation and a dummy operation of a vehicle heat exchanger combined controller according to an embodiment of the present disclosure;

FIG. 9 is a memory configuration diagram illustrating a vehicle control operation and a dummy operation of a vehicle heat exchanger combined controller according to an embodiment of the present disclosure;

FIG. 10 is a schematic diagram showing a method for a vehicle control operation and a dummy operation of a vehicle heat exchanger combined controller according to an embodiment of the present disclosure; and

FIG. 11 is a flowchart showing a heat exchange process according to an operation of a vehicle heat exchanger combined controller according to an embodiment of the present disclosure.

It can be understood that the appended drawings are not necessarily to scale, presenting a somewhat simplified representation of various features illustrative of principles of the present disclosure. The specific design features of example embodiments of the present disclosure as disclosed herein, including, for example, specific dimensions, orientations, locations, and shapes can be determined in part based on the particular intended application and use environment.

In the figures, reference numbers can refer to same or equivalent parts of embodiments of the present disclosure throughout the several figures of the drawing.

### DETAILED DESCRIPTION OF ILLUSTRATIVE EMBODIMENTS

Hereinafter, example embodiments of the present disclosure will be described in detail with reference to the accompanying drawings. Specific structural or functional descriptions presented in the example embodiments of the present disclosure are merely exemplified for the purpose of describing example embodiments of the present disclosure, and embodiments of the present disclosure may be implemented in various forms. A number of embodiments are disclosed herein. It can be understood that various features of the different embodiments can be combined. The present disclosure should not be construed as necessarily limited to the example embodiments described in this specification, and can be understood to include all modifications, equivalents, or substitutes included in the spirit and technical scopes of the present disclosure.

It can be understood that, although the terms “first”, “second”, etc. may be used herein to describe various elements, these elements are not necessarily limited by these terms. These terms can be used merely to distinguish one element from another. For example, a first element may be termed a second element, and, similarly, a second element may be termed a first element, without departing from the scopes of the example embodiments of the present disclosure.

It can be understood that, when an element is “connected” or “coupled” to another element, it may be directly connected or coupled to the other element, or may be indirectly connected or coupled to the other element with a different element being interposed therebetween. In contrast, when an element is “directly connected” or “directly coupled” to another element, there is no intervening element therebetween. Other expressions used to describe the relationship between elements can be interpreted in a similar manner (for example, “between” and “directly between”, “adjacent” and “directly adjacent”, etc.).

Wherever possible, same reference numbers can be used throughout the drawings to refer to same or like parts. Terminology used herein can be for the purpose of describing particular example embodiments and is not intended to necessarily limit potential embodiments of the present disclosure. As used herein, the singular forms “a”, “an”, and “the” can be intended to include the plural forms as well, unless the context clearly indicates otherwise. It can be understood that the terms “comprise”, “include”, and “have” used herein specify the presence of stated components, steps, operations, and/or elements, but do not preclude the presence or addition of one or more other components, steps, operations, and/or elements.

Hereinafter, example embodiments of the present disclosure will be described in detail with reference to the accompanying drawings.

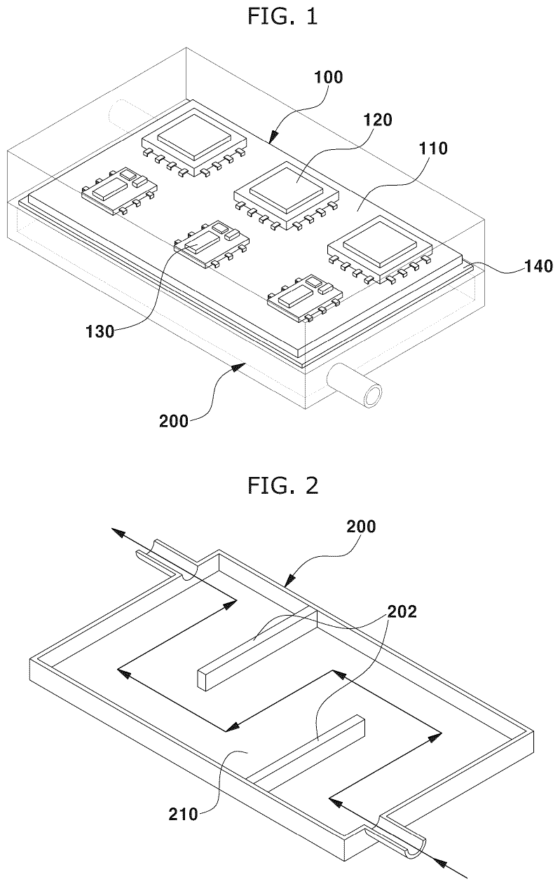

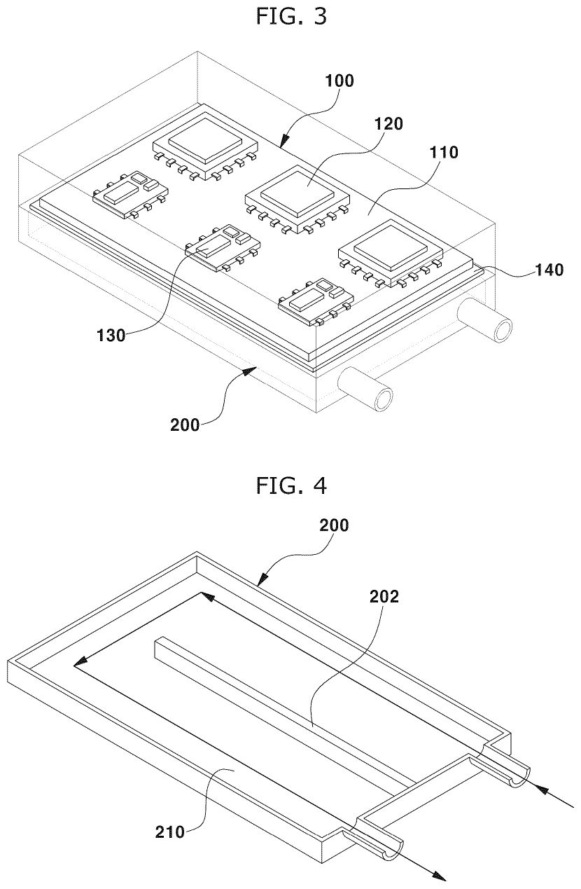

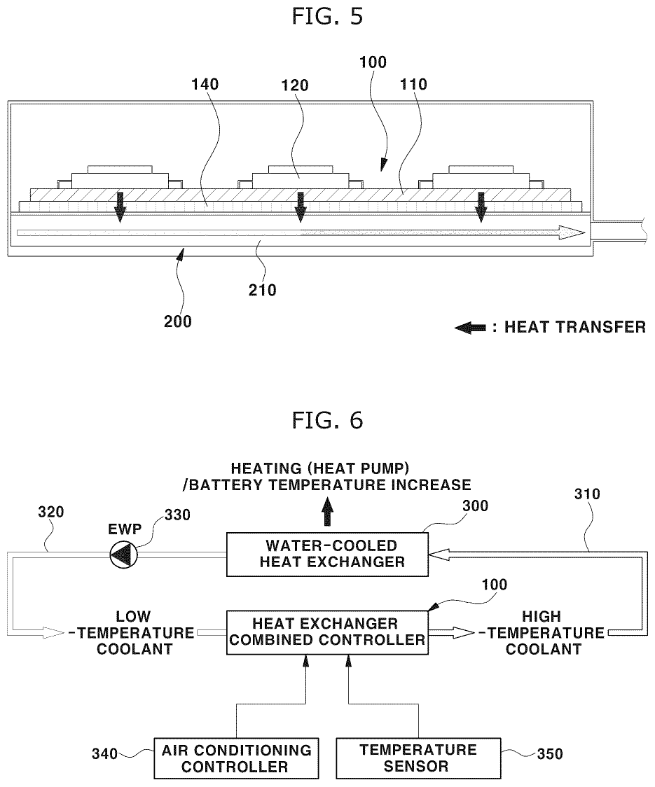

FIGS. 1 and 2 show a vehicle heat exchanger combined controller according to an embodiment of the present disclosure. FIGS. 3 and 4 shows a vehicle heat exchanger combined controller according to an embodiment of the present disclosure. FIG. 5 is a side-sectional view showing a vehicle heat exchanger combined controller according to an embodiment of the present disclosure.

A vehicle heat exchanger controller according to an embodiment of the present disclosure can include a controller 100 configured to perform a vehicle control operation and/or a dummy operation, and a heat exchange plate 200 formed with a coolant path 210 therein and attached to one surface of the controller 100, any of, any combination of, or all of which may be in plural or may include plural components thereof.

The controller 100 may be an integrated controller that performs a vehicle control operation, such as autonomous driving control, infotainment control, and various automotive electronics control, based on input signals for vehicle control, and can be configured to perform a dummy operation to emit heat to be used for heating and battery temperature increase.

As shown in FIG. 1 and FIG. 3, the controller 100 can be configured to include a printed circuit board (110, PCB), and a plurality of processors 120 and memories 130 mounted on the printed circuit board 110 by soldering to perform a vehicle control operation and/or a dummy operation for heat generation, any of, any combination of, or all of which may be in plural or may include plural components thereof.

As shown in FIG. 9, a memory area for controlling various devices including automotive electronics, a memory area for autonomous driving control, a memory area for infotainment control, a memory safety margin area, and a memory reserve area for a dummy operation can be allocated in the memory 130, any of, any combination of, or all of which may be in plural or may include plural components thereof.

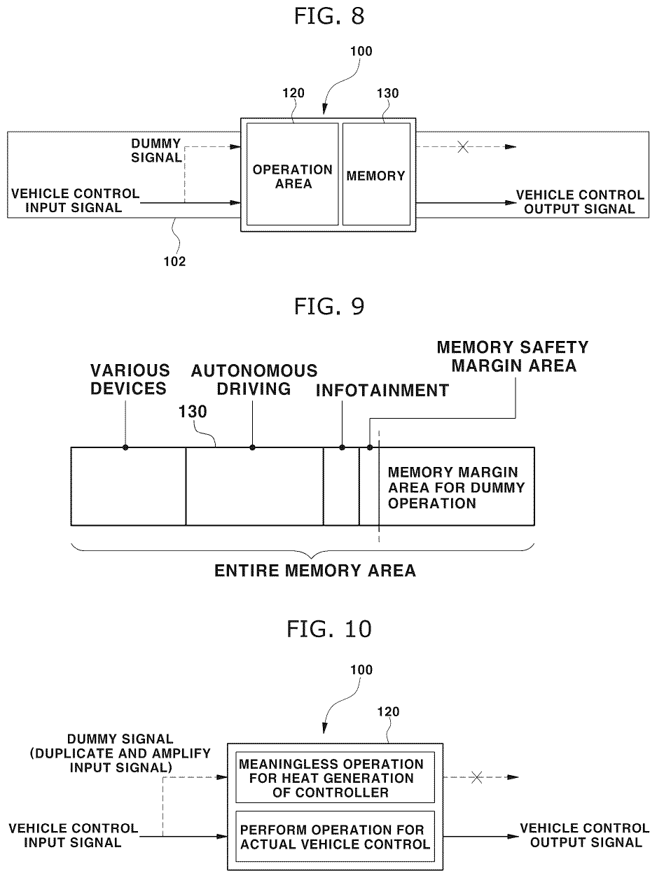

Further, as shown in FIG. 8, the controller 100 can further include a data input unit 102 that duplicates and amplifies a vehicle control input signal to generate a dummy signal, and can input the generated dummy signal to the processor 120.

As shown in FIG. 10, the processor 120 can be configured to perform an operation used for actual vehicle control, such as autonomous driving control, infotainment control, and various automotive electronics control, based on a vehicle control input signal input through the data input unit, and/or to repeatedly perform a meaningless operation for heat generation on the basis of a dummy signal input through the data input unit and not output a repeated operation signal.

For example, the processor 120 can repeatedly perform a meaningless operation for heat generation while generating meaningless variables by utilizing conditional statements such as ‘for’, ‘if’, and ‘while’, and not output a repeated operation signal, thereby increasing the amount of heat generated from the controller 100 including the processor 120.

As shown in FIG. 5, a heat sink 140 can transfer heat generated through the dummy operation of the controller 100 to the coolant path 210 of the heat exchange plate 200, which may be further attached to one side of the controller 100, such as a bottom surface of the printed circuit board 110.

According to an embodiment of the present disclosure, the heat exchange plate 200 can be provided with a rectangular shape as shown in FIG. 2, and at least two partitions 202 having a length smaller than the width of the heat exchange plate 200 can be formed therein in a zigzag form while maintaining a set, selected, or predetermined distance therebetween.

According to an embodiment of the present disclosure, by the two partitions 202, as shown in FIG. 2, the coolant path 210 in an “S” shape from a coolant inlet to a coolant outlet may be formed inside the heat exchange plate 200.

A heat exchange plate 200 according to an embodiment of the present disclosure can be provided with a rectangular shape in appearance as shown in FIG. 4, and a single partition 202 having a length smaller than the length of the heat exchange plate 200 can be formed therein.

According to an embodiment of the present disclosure, by the single partition 202, as shown in FIG. 4, a coolant path 210 in a “U” shape from a coolant inlet to a coolant outlet may be formed inside the heat exchange plate 200.

As described above, by forming the coolant path 210 of the heat exchange plate 200 in the “S” shape or the “U” shape, a time when a coolant remains in the coolant path 210 may be lengthened to increase the amount of the coolant remaining in the coolant path 210 compared to a straight path, and accordingly, it can be possible to increase the amount and efficiency of heat exchange between the heat generated from the controller 100 and the coolant flowing through the coolant path 210.

Accordingly, it can be possible to achieve heat exchange for transferring the heat generated by the dummy operation of the controller 100 to the coolant passing through the coolant path 210 of the heat exchange plate 200.

More specifically, as the controller 100 repeatedly performs a meaningless operation on the basis of the dummy signal to generate heat, the generated heat can be transferred to the coolant passing through the coolant path 210 of the heat exchange plate 200 through the heat sink 140, thereby heating the coolant passing through the coolant path 210 of the heat exchange plate 200.

In an embodiment of the present disclosure, a configuration of a heat management system including the above-mentioned vehicle heat exchanger combined controller can be as follows.

FIG. 6 is a coolant circulation flow diagram showing a heat management system including a vehicle heat exchanger combined controller and a water-cooled heat exchanger according to an embodiment of the present disclosure.

Referring to FIG. 6, the heat exchanger combined controller 100 according to an embodiment of the present disclosure may be configured to enable coolant circulation in the heat management system for heat exchange for converting a low-temperature coolant into a high-temperature coolant.

The heat exchange plate 200 provided on one surface of the controller 100 and a water-cooled heat exchanger 300 can be connected for coolant circulation.

A first coolant circulation line 310 can be connected between an outlet of the coolant path 210 of the heat exchange plate 200 and an inlet of the water-cooled heat exchanger 300, and a second coolant circulation line 320 can be connected between an outlet of the water-cooled heat exchanger 300 and an inlet of the coolant path 210 of the heat exchange plate 200.

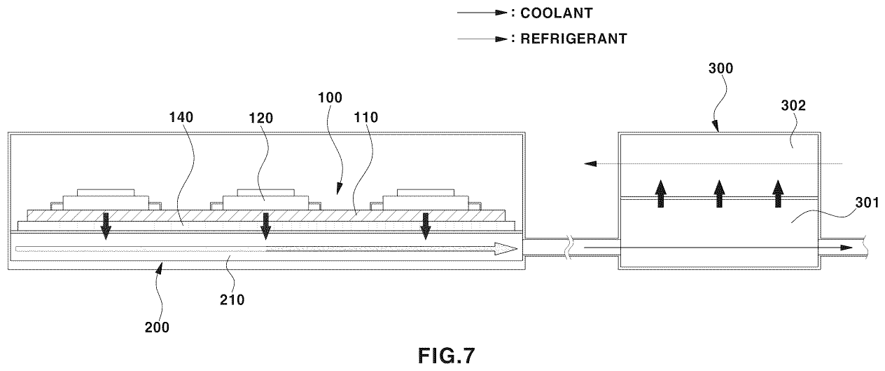

The water-cooled heat exchanger 300 can be configured to recover heat for heating and/or battery temperature increase, and may have a structure in which a coolant flow path 301 and a refrigerant flow path 302 can be separately partitioned, as shown in FIG. 7.

An electric water pump 330 that circulates coolant can be mounted on the second coolant circulation line 320.

An air conditioning controller 340 can be connected to the controller 100 to transmit a signal for notifying the controller 100 that the amount of heat for heating and/or battery temperature increase is insufficient compared to a reference amount of heat.

A temperature sensor 350 can be connected to the controller 100 to detect the temperature of the coolant passing through the coolant path 210 of the heat exchange plate 200 and transmit a detection signal to the controller 100.

An operation flow of the heat management system using the above-mentioned vehicle heat exchanger combined controller can be as follows.

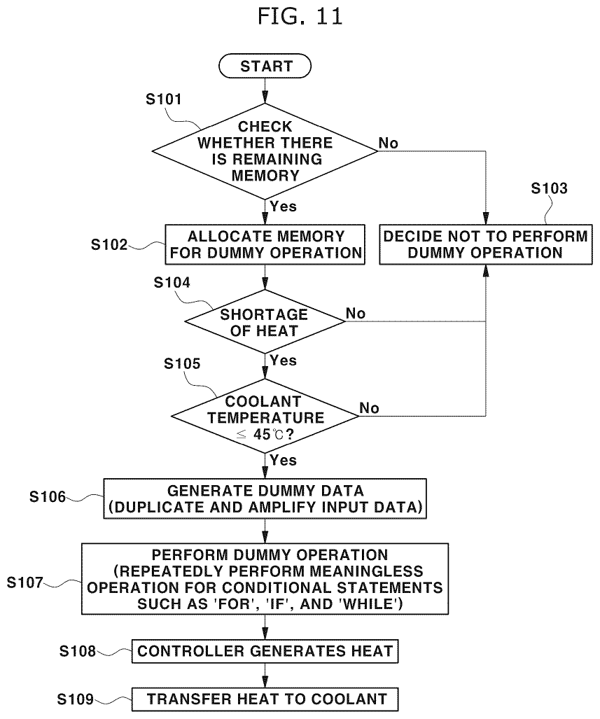

FIG. 11 is a flowchart showing a heat exchange process according to an operation of a vehicle heat exchanger combined controller according to an embodiment of the present disclosure.

The controller 100 can check whether there is any remaining space in the memory 130 (operation S101).

As a result of the checking in operation S101, in a case where there is remaining space in the memory, the controller 100 can allocate memory for a dummy operation (operation S102).

The controller 100 can allocate the remaining memory area other than a memory area for controlling various devices including automotive electronics, a memory area for autonomous driving control, and a memory area for infotainment control as the memory for a dummy operation.

On the other hand, in a case where there is no remaining space in the memory as a result of the checking in operation S101, the controller 100 can decide to not perform the dummy operation (operation S103).

The controller 100 can determine whether there is a shortage of heat for heating and/or battery temperature increase (operation S104).

The air conditioning controller 340 can transmit a signal for notifying the controller 100 that the amount of heat for heating and/or battery temperature increase is sufficient or insufficient compared to a reference amount of heat, and accordingly, the controller 100 may determine whether the amount of heat for heating and/or battery temperature increase is sufficient or insufficient.

The controller 100 can determine whether the temperature of the coolant is equal to or below a reference temperature (e.g., 45° C.) (operation S105).

The temperature sensor 350 can detect the temperature of the coolant passing through the coolant path 210 of the heat exchange plate 200 and transmit the result to the controller 100, and accordingly, the controller 100 may determine whether the temperature of the coolant is equal to or below the reference temperature (e.g., 45° C.).

In an example where there is no shortage of heat for heating and/or battery temperature increase and the temperature of the coolant is higher than the reference temperature, the controller 100 cannot perform the dummy operation.

On the other hand, in an example where there is the shortage of heat for heating and/or battery temperature increase and the temperature of the coolant is equal to or below the reference temperature, the controller 100 may perform the dummy operation.

The data input unit 102 of the controller 100 can duplicate and amplify a vehicle control input signal to generate a dummy signal (operation S106).

The generated dummy signal can be input to the processor 120 of the controller 100.

Accordingly, the dummy operation can be performed in the processor 120 of the controller 100 (operation S107).

The processor 120 can repeatedly perform a meaningless operation for heat generation while generating meaningless variables using conditional statements such as ‘for’, ‘if’, and ‘while’, and cannot output a repeated operation signal, thereby increasing the amount of heat generated from the controller 100 including the processor 120.

Accordingly, as the processor 120 of the controller 100 repeatedly performs the dummy operation, the controller 100 can generate heat (operation S108).

The heat generated through the dummy operation of the controller 100 may be transferred to the coolant flowing through the coolant path 210 of the heat exchange plate 200 through the heat sink 140 (operation S109).

As the coolant passing through the coolant path 210 of the heat exchange plate 200 is heated and passes through the water-cooled heat exchanger 300 along the first coolant circulation line 310, the heat for heating and/or battery temperature increase may be recovered from the heated coolant.

For example, where the coolant passing through the coolant path 210 of the heat exchange plate 200 is heated and then flows through the coolant flow path 301 of the water-cooled heat exchanger 300 along the first coolant circulation line 310 as shown in FIG. 7, heat can be exchanged with the low-temperature refrigerant flowing through the refrigerant flow path 302 of the water-cooled heat exchanger 300, so that the refrigerant can be heated, and the heated refrigerant can be used for heating or battery temperature increase.

Using an embodiment of the present disclosure, as the controller 100 repeatedly performs a meaningless operation on the basis of the dummy signal to generate heat and the generated heat is transferred to the coolant passing through the coolant path 210 of the heat exchange plate 200 through the heat sink 140, it can be possible to heat the coolant passing through the coolant path 210 of the heat exchange plate 200, and to use the high-temperature coolant heated by the heat exchange for heating and/or battery temperature increase, for example.

According to an embodiment of the present disclosure, by mounting a heat exchange plate having a coolant path in a controller capable of performing a dummy operation, and performing heat exchange between heat generated by the dummy operation of the controller and a coolant passing through the coolant path of the heat exchange plate, it can be possible to use the coolant after heat exchange for heating and/or battery temperature increase, for example.

By replacing an existing heat exchanger provided in a heat management system with a heat exchanger combined controller, it can be possible to reduce the number of parts and cost.

The present disclosure has been described in detail with reference to example embodiments thereof. However, it can be appreciated by those skilled in the art that changes may be made in these embodiments without departing from the principles and spirit of the present disclosure, the scopes of which can be defined in the appended claims and their equivalents.

What is claimed is:

1. A vehicle heat exchange system comprising:
a controller configured to perform a vehicle control operation and a dummy operation; and
a heat exchange plate having a coolant path therein and attached to a surface of the controller,
wherein the heat exchange plate is configured so that heat exchange can be performed between heat generated by the dummy operation of the controller and a coolant passing through the coolant path of the heat exchange plate.

2. The system according to claim 1, wherein the controller comprises:
a printed circuit board; and
one or more processors and memories mounted on the printed circuit board, wherein the one or more processors and memories are configured so that the one or more processors can perform the vehicle control operation and the dummy operation for heat generation.

3. The system according to claim 2, wherein the controller further comprises a data input configured to replicate and amplify a vehicle control input signal to generate a dummy signal, and wherein the data input is configured to input the generated dummy signal to the one or more processors.

4. The system according to claim 3, wherein the one or more processors are configured to repeatedly perform a meaningless operation for heat generation based on the dummy signal input from the data input and not output a repeated operation signal based on the meaningless operation.

5. The system according to claim 1, further comprising a heat sink attached to a first side of the controller, wherein the heat sink is configured to transfer heat generated by the dummy operation to the coolant path of the heat exchange plate.

6. The system according to claim 1, further comprising at least two partitions in the heat exchange plate, wherein each of the at least two partitions has a length smaller than a width of the heat exchange plate, and wherein the at least two partitions are configured in a zigzag structure so that the coolant path includes an “S” shape from a coolant inlet to a coolant outlet.

7. The system according to claim 1, further comprising a single partition in the heat exchange plate, wherein the single partition has a partition length smaller than a heat-exchange-plate length of the heat exchange plate, so that the coolant path includes a “U” shape from a coolant inlet to a coolant outlet.

8. A heat management system comprising:
a controller configured to perform a vehicle control operation and a dummy operation;
a heat exchange plate having a coolant path therein and attached to a surface of the controller;
a water-cooled heat exchanger configured to recover heat for heating or battery temperature increase;
a first coolant circulation line connected between a heat-exchange-plate outlet of the coolant path of the heat exchange plate and a water-cooled-heat-exchanger inlet of the water-cooled heat exchanger; and
a second coolant circulation line connected between a water-cooled-heat-exchanger outlet of the water-cooled heat exchanger and a heat-exchange-plate inlet of the coolant path of the heat exchange plate.

9. The system according to claim 8, further comprising an air conditioning controller configured to transmit a signal for notifying the controller that an amount of heat for heating or battery temperature increase is insufficient compared to a reference amount of heat.

10. The system according to claim 8, further comprising a temperature sensor configured to detect a temperature of a coolant passing through the coolant path of the heat exchange plate and transmit a detection signal to the controller.

11. The system according to claim 8, further comprising an electric water pump that is mounted on the second coolant circulation line and configured to circulate a coolant.

12. The system according to claim 8, wherein the controller comprises:
a printed circuit board; and
one or more processors and memories mounted on the printed circuit board, wherein the one or more processors and memories are configured so that the one or more processors can perform the vehicle control operation and the dummy operation for heat generation.

13. The system according to claim 12, wherein the controller further comprises a data input configured to duplicate and amplify a vehicle control input signal to generate a dummy signal, and wherein the data input is configured to input the generated dummy signal to the one or more processors.

14. The system according to claim 13, wherein the one or more processors are configured to repeatedly perform a meaningless operation for heat generation based on the dummy signal input from the data input and not output a repeated operation signal based on the meaningless operation.

15. The system according to claim 8, further comprising a heat sink attached to a first side of the controller, wherein the heat sink is configured to transfer heat generated by the dummy operation to the coolant path of the heat exchange plate.

16. The system according to claim 8, wherein the system is configured so that a coolant passing through the coolant path of the heat exchange plate is heated by heat generated by the dummy operation of the controller and passes through the water-cooled heat exchanger along the first coolant circulation line, and so that heat for heating or battery temperature increase is recovered from the coolant.

17. A method of generating heat for a vehicle system, the method comprising:
performing dummy operations in a controller to generate heat by controller components of the controller;
flowing a coolant through a heat exchange plate to transfer the heat generated by the controller components of the controller to the coolant; and
heating a vehicle component of the vehicle system with the coolant after the flowing of the coolant through the heat exchange plate.

18. The method of claim 17, further comprising:
checking whether memory space is remaining;
allocating at least part of the memory space to instructions for the dummy operations based on the memory space being remaining;
generating dummy data for the dummy operations; and
providing the instructions and the dummy data for the dummy operations to one or more processors of the controller components.

19. The method of claim 17, wherein the performing of the dummy operations comprises:
duplicating and amplifying a vehicle control input signal to generate a dummy signal; and
repeatedly perform a meaningless operation for heat generation based on the dummy signal.

20. The method of claim 17, wherein results of the dummy operations are non-outputted data.
